(19) United States
(12) Patent Application Publication
(10) Pub. No.: US 2010/0053741 A1
(43) Pub. Date: Mar. 4, 2010

(54) OPTICAL IMAGING SYSTEM

(75) Inventor: Ulrich Sander, Rebstein (CH)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA MICROSYSTEMS (SCHWEIZ) AG, Heerbrugg (CH)

(21) Appl. No.: 12/551,219

(22) Filed: Aug. 31, 2009

(30) Foreign Application Priority Data
Sep. 4, 2008 (DE) 102008041819.6

(51) Int. Cl. G02B 21/22; G02B 21/02

(52) U.S. Cl. 359/376; 359/380

(57) ABSTRACT

An optical imaging system is described, comprising a zoom system for adjusting a variable magnification of the image, wherein the zoom system comprises at least one of a lens assembly and a first SLM optical unit, and an illumination system for illuminating an object to be imaged in an object plane. The illumination system has a second SLM optical unit for adjusting the focal length within the illumination system. This design allows coordinating zoom system and illumination system with one another in a simple manner and provides a compact design.

### CROSS-REFERENCE TO RELATED APPLICATION

This application claims the priority of the German patent application DE 102008041819.6 having a filing date of Sep. 4, 2008. The entire content of this prior German patent application DE 102008041819.6 is herewith incorporated by reference.

### BACKGROUND OF THE INVENTION

The present invention relates to an optical imaging system, in particular microscope system, comprising a zoom system for setting a variable magnification of the imaging, wherein the zoom system has at least one lens assembly and/or at least one SLM optical unit, and an illumination system for illuminating an object to be imaged.

Such optical imaging systems, in particular embodied as microscopes, in particular stereomicroscopes, are generally known. Stereomicroscopes have two channels each having a zoom system for synchronously altering the imaging magnification. Such a zoom system is known from U.S. Pat. No. 6,853,494 B2, for example. The zoom system proposed therein comprises two outer stationary lens assemblies and two inner movable lens assemblies, the latter of which are mounted displaceably in a predetermined manner in the direction of the optical axis of the zoom system. Instead of zoom systems, for example in diagnosis microscopes, it is also possible to use magnification changers with fixed magnification factors. For this purpose, the corresponding optical units are mounted rotatably on a roller and can be introduced into the beam path by rotation of the roller depending on the desired magnification factor. The basic construction of a microscope having a magnification changer (discrete or zoom system) is illustrated and described for example in Lang, Muchel: “ZEISS Microscopes for Microsurgery”, Berlin, 1981, page 6.

Further zoom systems are known in the documents DE 1 293 470 OS for monoscopic viewing and from EP 1 431 796 B1 for stereoscopic viewing.

Since the zoom elements in a zoom system have to be displaced highly precisely and, in stereomicroscopes, synchronously in the two zoom systems, the driving of zoom systems constitutes a major technical challenge. Moreover, the need for displaceable lens assemblies necessitates a correspondingly large structural volume of the zoom system.

DE 103 49 293 A1 proposes the use of a lens having an adjustable refractive power for the zoom systems in the left and right stereo channels of a stereomicroscopy system in order to provide a changeable magnification without changing the position of a lens assembly. The proposed lens having an adjustable refractive power is, on the one hand, a liquid crystal lens that can be driven by means of an electrode structure, and is, on the other hand, a pure liquid lens comprising two immiscible liquids having different refractive indices in a housing with two electrodes, wherein the angle between the interface of the two liquids and the wall surrounding the latter can be altered by changing the voltage between the electrodes. A change in this angle leads to a change in the lens effect of the liquid lens. The zoom optical unit proposed in this document has a plurality of lens assemblies each comprising a first lens having a positive refractive power, a second lens having a negative refractive power, and a third lens having an adjustable refractive power. When using only one lens assembly having a lens having an adjustable refractive power, in accordance with said document two further lens assemblies are required, one (the central one) of which is in turn mounted displaceably along the optical axis of the zoom optical unit. Even though, in accordance with said document, when using two lenses having an adjustable refractive power in a zoom optical unit, the need for displaceability of a lens assembly along the optical axis of the zoom optical unit is obviated, the disadvantage nevertheless remains that the optical unit used having a displaceable lens assembly is excessively voluminous and the desire of users, in particular those of surgical microscopes, for microscopes having a small construction cannot be fulfilled, or else the zoom optical unit without a displaceable lens assembly in the longitudinal direction is too short in construction to correct image aberrations well enough (“screened zoom system”).

In order to fulfil the desire of users for a small structural height, US 2001/0010592 A1 proposes a stereomicroscope comprising a so-called “horizontal zoom system”. Here the zoom systems of the two channels of the stereomicroscope are arranged alongside one another in the same horizontal plane, wherein the optical axis of the main objective is perpendicular to this plane. For this purpose, a deflection element is provided, which deflects the (vertical) observation beam path into said (horizontal) plane in which the two zoom systems of the stereomicroscope are arranged. In the case of the stereomicroscope proposed therein, further beam splitters and deflection elements can be provided in order suitably to couple out the beam path to (co-)observers and/or to feed it to a (main) observer at a suitable location. Although the stereomicroscope described therein has a structural height that is kept small, the depth extent of said stereomicroscope is nevertheless enlarged, which can have a disturbing effect for the user or users, particularly if the microscope is used as a surgical microscope.

Here and hereinafter the direction indications “vertical” and “horizontal” refer to the normal operating position of an optical imaging system, in particular of a microscope.

The documents U.S. Pat. No. 6,304,374 B1 and DE 43 36 715 C2 describe a stereomicroscope comprising a common main objective for the right and left channels of the stereomicroscope and an afocal magnification system common to the right and left channels, and also comprising a binocular tube for observing the object light emerging from the afocal magnification system. The zoom system used therein is thus monoscopic; the stereoscopic splitting for enabling three-dimensional viewing takes place only after the emergence of the beam path from the zoom system. Such a system has the major disadvantage that the three-dimensional viewing (“stereopsis”) is dependent on the magnification of the zoom system. This is not accepted by most users. Furthermore, in the case of the systems proposed therein, the zoom system is arranged horizontally and, in addition, the zoom system itself contains deflection elements (prisms) for directing the beam path into two horizontal planes lying one above another. Furthermore, that part of the zoom system which is situated in the first horizontal plane is arranged on a common axis behind and with the main objective. For this purpose, a further deflection mirror is necessary, which directs the object light into the main objective, with the result that the system overall requires at least four deflection elements.

Since the magnification-dependent stereopsis is not desired by the user, the applicant proposed, in U.S. Pat. No. 7,057,807 B2 and also in EP 1 424 581 B1 and EP 1 460 466 B1, a microscopy system which always contains at least two optical zoom channels arranged “horizontally”, thus affording the advantage of a small structural height in conjunction with magnification-independent stereopsis. If co-observation by an assistant with full spatial resolution is desired, a total of four channels (two for the main observer, two for the assistant) are required.

In the case of the construction in accordance with U.S. Pat. No. 7,057,807 B2 cited above, three horizontal planes parallel to one another are present; deflection elements serve for deflecting the beam paths into the respective horizontal planes. The zoom systems for the main observer lie for example in the second (central) horizontal plane, while the zoom systems for the assistant are arranged in the third (upper) horizontal plane. The cited documents EP 1 424 581 B1 and EP 1 460 466 B1 specify further possibilities of coupling out for an assistant in the different horizontal planes. The zoom systems used therein are in each case always situated in one of the horizontal planes.

Finally, in a different context, DE 10 2006 022 073 A1 in the name of the applicant discloses a method for operating a microscope with an illumination unit for illuminating an object viewed using the microscope, wherein the working distance of the microscope is variable and the illumination and observation beam paths in each case run through the main objective of the microscope. In the case of the method proposed, the light intensity in the object plane is regulated depending on the working distance in accordance with a predetermined profile. In accordance with a further aspect, the light intensity in the eyepiece is jointly regulated depending on an actuation of a zoom system of the microscope and a focal length change of the main objective of the microscope. For these regulations, use is made of sensors that detect changes in the light intensities. The light intensity can be regulated either by driving the electrical power supply of the lamp of the illumination unit or by varying the transmission of an optical element (transmission or interference filter) or by driving a diaphragm inserted into the illumination aperture, or finally by driving the illumination optical units, for instance by displacing a displaceable lens or lens group (illumination zoom) in the direction of the illumination beam path. Such a displacement results in a focusing or defocusing of the illumination beam path with corresponding variation of the brightness. In this context it is desirable to realize a simplest possible regulation of the light intensity in the object plane or in the eyepiece with the fewest possible components.

### SUMMARY OF THE INVENTION

It is an object of the present invention to specify an optical imaging system, in particular a microscope system, comprising a zoom system and an illumination system, in which zoom system and illumination system can be coordinated with one another in a simple manner, and which achieves in its configurations, in particular, a design that is as compact as possible, without the disadvantages mentioned above.

This is achieved by an optical imaging system comprising: a zoom system for adjusting a variable magnification of the image, wherein the zoom system comprises at least one of a lens assembly and a first SLM optical unit, and an illumination system for illuminating an object to be imaged in an object plane, wherein the illumination system has a second SLM optical unit for adjusting the focal length within the illumination system.

The optical imaging system according to the invention, in particular comprising a microscope, which comprises a zoom system for setting a variable magnification of the imaging, wherein the zoom system has at least one lens assembly and/or at least one SLM optical unit, and which comprises an illumination system for illuminating an object to be imaged which is situated in an object plane, is wherein the illumination system has an SLM optical unit for setting the focal length within the illumination system.

In the present application, the term “SLM optical unit” is intended to be used as a collective term for optoelectronic elements which can influence the amplitude and/or phase of light wavefronts in a high-resolution manner. The abbreviation “SLM” stands for “Spatial Light Modulator”. This generally involves electronically driveable arrays (optically driveable SLMs also exist) which can be driven at each point of the array in order to change the impinging beam profile. A summary of SLM technology may be found for example in Sven Krüger et al., “Schaltbare diffraktiv-optische Elemente zur Steuerung von Laserlicht” [“Switchable Diffractive-Optical Elements for Controlling Laser Light”], Photonik January 2004, page 46 et seq.

SLM optical units can also specifically be used for focusing and/or magnification. Liquid crystal optical units, such as liquid crystal lenses, having a variable, adjustable focal length are known (cf. Photonik May 2003, page 14, “Flüssigkristall-Optik”[“Liquid Crystal Optics”] and also Optics & Laser Europe (OLE), May 2006, page 11 (“Liquid Crystals ease bifocal strain”). One embodiment of such a liquid crystal lens comprises a liquid crystal layer between two glass layers, wherein the glass layers are coated with concentric transparent electrode rings. By changing a voltage applied to the electrode rings, these liquid crystal lenses vary their focal length. A further possibility is afforded by so-called “EAP lenses” (EAP=Electroactive Polymer), in which the refractive power of the lens can be varied by applying an electrical voltage. Such elements are outstandingly suitable for wholly or partly replacing the conventional lenses present in a video adapter. Simple focus setting is made possible by this means. In the case of zoom systems, the use of SLM optical units can make displaceable zoom elements superfluous. Since the driving is effected electronically, it is additionally possible to dispense with previously conventional motors for displacing lens groups as a whole or relative to one another.

The SLM optical unit can be a reflective microdisplay, in particular a reflective liquid crystal display (LCD). Such reflective LCDs can be realized for example as LCoS light modulators (Liquid Crystal over Silicon). With regard to the construction and functioning of a reflective LCoS microdisplay, reference should be made to the cited article by Sven Krüger et al.

LCD systems have the advantage of small addressable structures, height resolution and high dynamic range. It is possible to realize amplitude and phase modulations with high precision and with short response times. Consequently, it can be used for beam shaping, beam splitting, dynamic aberration correction, etc. Besides the relatively new reflective LCDs, transmissive microdisplays (“electronic transparency”) such as transmissive liquid crystal displays, have been known for a relatively long time, and can likewise advantageously be used for the invention.

A further important representative of SLM optical units is micromirror arrays having individually drivable micromirrors which can be set in terms of their spatial orientation (DMD, Digital Micromirror Device). Such micromirror arrays can be used for beam deflection and beam splitting. If the micromirrors are suitably oriented in spherical or aspherical fashion (or more generally: in non-planar fashion) in terms of their orientation, then a micromirror array can also be used for focusing and/or for optical correction. With regard to the technical principles and possible uses, reference should be made to the article “DLP Technologie—nicht nur für Projektoren und Fernsehen” [“DLP Technology—not just for projectors and television”] in Photonik January 2005, pp. 32-35.

The use according to the invention of SLM optical units both in the illumination system and in the zoom system of the optical imaging system affords surprising diverse advantages which have the effect that conventional optical imaging systems can be realized technically much more simply than heretofore and, in particular, in significantly smaller, lighter and more compact fashion and with less noise and with significantly shorter response times and more precise driving.

The abovementioned SLM optical units, which can have a focusing effect, are suitable as SLM optical unit for setting the focal length within the illumination system. For this purpose, micromirror arrays are suitable, for example, by setting a suitable aspherical or spherical or more generally non-planar orientation of the micromirrors. Furthermore, the already mentioned liquid crystal lenses or EAP lenses having a variable, adjustable focal length are suitable for this purpose.

The use according to the invention of an SLM optical unit for setting the focal length within the illumination system together with the use of an SLM optical unit in a zoom system of the optical imaging system has the following advantages:

Firstly, the optical unit of the zoom system can be made less voluminous than that of previously conventional zoom systems comprising (at least one) displaceable lens assembly which has (or have) to be displaced highly precisely and electromechanically depending on the magnification factor. Furthermore, it is possible to fulfil an often expressed desire of users to change over the magnification in a zoom system analogously to that of a discrete changer directly from one magnification level to another desired level without having to continuously pass through all the intermediate values. On account of the use of an SLM optical unit, the changeover between magnification levels can be performed by electrical driving in a manner free of delay.

In particular, however, the invention permits a delay-free and synchronous adaptation of the illumination to changing zoom settings (and vice versa). Depending on the zoom setting (increasing the magnification), as is known the observation field changes (observation field becoming smaller and decreasing brightness), such that, for optimum microscopic viewing, the illumination field should be correspondingly adapted in terms of geometry and brightness. The SLM optical units mentioned are optimally suitable for this purpose. When the magnification is increased, a reduction of the luminous fields with increasing light intensity is effected by means of the SLM optical unit.

In addition to the abovementioned setting possibilities by means of focusing SLM optical units, for example the brightness and/or geometry of the illumination can additionally also be controlled by means of a (transmissive or reflective) microdisplay.

If the illumination unit has an illumination zoom system, then movable lens elements in the illumination zoom system can furthermore be dispensed with by using one or more SLM optical units analogously to the zoom system of the optical imaging system. The advantages already discussed in connection with the zoom system of the optical imaging system arise from this in an analogous manner.

Overall, therefore, the incorporation of an SLM optical unit into an illumination unit of an optical imaging system affords the possibility of varying the focal length within the illumination unit and/or the brightness and/or the geometry of the luminous field electronically in a targeted manner and of coupling these variables to the respective settings of the zoom system in a targeted manner. For this purpose, a control unit can be provided, which jointly suitably drives the SLM optical units of the zoom system of the optical imaging system and of the illumination (zoom) system. This permits a significantly simpler coupling than in previous systems.

In conventional microscope systems that will be treated here as an example of an optical imaging system, there are various possibilities for arranging the illumination system. The latter can illuminate the object field independently of the microscope as an autonomous unit with associated optical unit. In another configuration, by means of a deflection element, the illumination beam path is directed onto the object plane via the (main) objective of the microscope. The present invention can be used for both types of illumination systems. If the illumination system contains an illumination zoom system, this affords the advantageous possibility of utilizing the existing zoom system of the optical imaging system as an illumination zoom system. By means of a suitable deflection element, the illumination beam path is directed for example into one of the two observation channels into the zoom system of the optical imaging system, wherein the illumination beam path is then once again directed onto the object plane via the (main) objective of the microscope. This configuration has the advantage that the number of components is reduced, and that in particular the illumination setting changes automatically with a zoom setting.

The present invention makes it possible highly advantageously to realize a variant of the construction of a “horizontal zoom system” already discussed above, namely by using the at least one SLM optical unit of the zoom system of the optical imaging system as a deflection element. The deflection element can direct the observation beam path for example from a vertical direction into a horizontal direction, wherein parts of the zoom system are arranged in a corresponding horizontal plane. SLM optical units suitable as deflection elements are reflective microdisplays or micromirror arrays, for example. A further advantage when using these SLM optical units is that they can also realize other functions, namely for example focus settings and optical corrections (micromirror arrays) or brightness and geometry settings (reflective microdisplays and micromirror arrays). A further possible arrangement consists in arranging parts of the zoom system in a horizontal plane, wherein an SLM optical unit acting as a deflection element within the zoom system deflects the observation beam path in a (substantially) vertical direction in which the further parts of the zoom system are arranged. After leaving the zoom system, the observation beam path can be directed into a further horizontal plane for example by means of a further deflection element (traditional or SLM optical unit).

With regard to the abovementioned further functions in particular in connection with the use of micromirror arrays, it should be explained that a focusing effect of the micromirror array can be achieved by means of a spherical or aspherical orientation of the micromirrors (more generally non-planar orientation), wherein optical corrections can additionally be performed. As an alternative or in addition, specific regions of the micromirror array can reflect impinging light out of the main beam path, such that this light is no longer available for further observation (or illumination). The brightness can be influenced in this way. Finally, beam shaping (geometry setting) can be effected through suitable orientation of the micromirrors.

It should be noted in this context that all of the configurations discussed here, and configurations yet to be discussed, of the zoom system of the optical imaging system within which a deflection element is present also hold true in an entirely analogous manner for an illumination zoom system of the illumination system and can be applied thereto.

It is furthermore advantageous if a plurality (at least two) of SLM optical units are present in the zoom system of the optical imaging system, at least two of which are used as deflection elements. The components of the zoom system of the optical imaging system can thereby be distributed for example between two (horizontal) planes.

In addition to the advantages of the “horizontal zoom system” already discussed, the configurations mentioned afford the following further advantages: In the case of the previous zoom systems, owing to the small structural height required, it was always particularly difficult to realize optimal image correction. The shorter the construction of a zoom system, the more difficult it is to correct the image aberrations; the optical system is then “strained”. This also applies to (one-piece) “horizontal zoom systems”, owing to the small depth extent required. Although previously known zoom systems with an SLM optical unit can avoid the use of movable lens structural elements, on account of their small axial extent they are likewise “strained”, that is to say difficult to control with regard to image aberration corrections.

The particularly advantageous possibilities outlined above for distributing the components of the zoom system of the optical imaging system between more than only one (horizontal) plane makes it possible to provide the zoom system with a long construction, that is to say to “relax” said zoom system, and thus to optimally correct image aberrations.

The SLM optical unit of the zoom system functioning as a deflection element in accordance with this configuration can be used for both zoom channels given appropriate spatial design. As an alternative, each of the two zoom systems of a stereomicroscope is provided with an SLM optical unit functioning as a deflection element. In application to stereomicroscopes, there should always be one zoom system per channel of the stereomicroscope, in order to avoid a magnification-dependent stereopsis.

In the particularly advantageous configuration just described, it is also conceivable, in principle, for the SLM optical unit present in the zoom system not to perform the function of the deflection element, rather for a traditional mirror or a prism to perform this function. By contrast, if use is made of concave mirrors or prisms having a curved surface or similar deflection elements comprising refractive power, a focusing effect can simultaneously be achieved. The same applies to the micromirror arrays (SLM optical unit) already mentioned which can furthermore be used to achieve a time-dependent or magnification-dependent refractive power.

It should again be pointed out that the configurations of the “horizontal” zoom system that have been outlined, in particular also in connection with the “relaxed” zoom system, can be applied to an illuminating zoom system of the illumination system in an analogous way. In order to avoid repetition, the corresponding configurations of an illumination zoom system are not presented in specific detail here, since the person skilled in the art can apply the discussed configurations of the zoom system of the optical imaging system to an illumination zoom system.

A further advantageous embodiment of the invention consists in the fact that a delay-free changeover between different operating states of the optical imaging system is possible on account of the SLM optical units used in the optical imaging system. A situation in the case of an opthalmological surgical microscope shall be presented as an example of this. If the surgeon carries out e.g. firstly a cataract operation and then directly afterwards a retina operation, he requires, for each of these two operating procedures, different, defined and constant magnifications and corresponding different and defined illuminations of the object field. The desired defined magnification can be set (automatically) by means of corresponding electronic driving of the SLM optical unit of the zoom system. The same applies analogously to the illumination, by driving the SLM optical unit of the illumination system. The change from one operation procedure to the next operation procedure is possible for example semi-automatically (pushbutton actuation, acoustic signal or the like), wherein a control unit thereupon sets the corresponding parameters for the SLM optical units. In this way, magnification and illumination can be set synchronously and in a manner free of delay appropriately for the respective operation procedure.

It should be pointed out that the various features of the invention outlined and the configurations thereof can be used not only in the combination presented here, but also in other combinations or by themselves, without departing from the scope of the present invention.

The invention and its advantages will be explained in greater detail below on the basis of exemplary embodiments illustrated in the drawing.

### BRIEF DESCRIPTION OF THE DRAWINGS

FIG. 1 schematically shows a known optical imaging system with a stereomicroscope in longitudinal section,

FIG. 2 schematically shows a zoom system (or illumination zoom system) with SLM optical unit,

FIG. 3 schematically shows a zoom system with SLM optical unit in a further embodiment;

FIG. 4 once again schematically shows a zoom system with SLM optical unit in a further configuration.

### DETAILED DESCRIPTION OF THE DRAWINGS

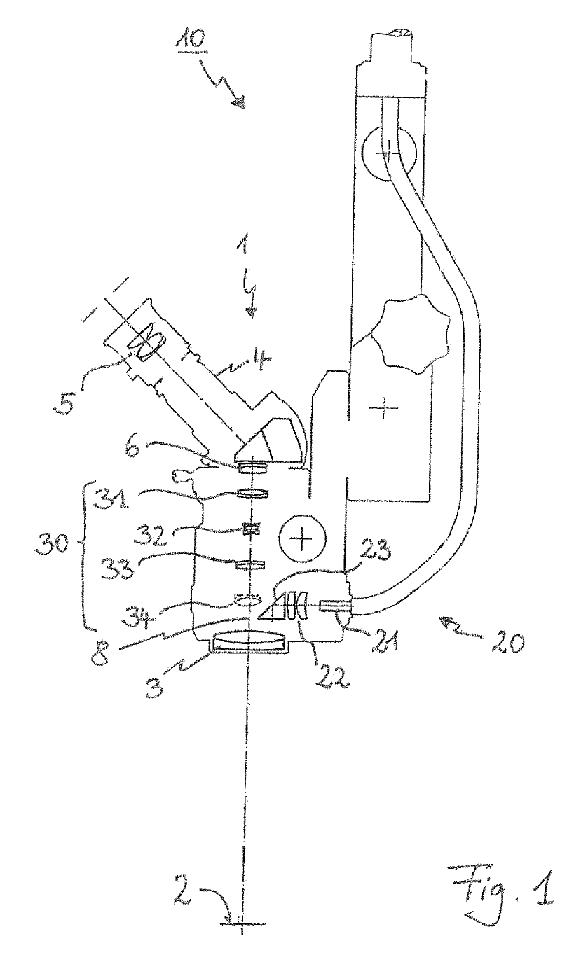

FIG. 1 shows highly schematically an optical imaging system such as is known for example from the prior art (cf. W. H. Lang, F. Muchel: “ZEISS Microscopes for Microsurgery” Berlin 1981, page 6), a longitudinal section through a stereomicroscope 1 with an illumination system 20 being illustrated. The optical imaging system or here stereomicroscope system is designated in an all-encompassing manner by 10. Since a system in accordance with FIG. 1 is known per se, only a rough overview will be given below. Details regarding the construction and functions may be found in the prior art cited in the introductory part of the description. The stereomicroscope system 10 comprises a stereomicroscope 1 and an illumination system 20. The stereomicroscope 1 essentially comprises a main objective 3, a zoom system 30 for (continuously variably) setting a variable magnification of the imaging, a tube lens 6 and also an eyepiece 5. Only one observation channel of the stereomicroscope 1 is illustrated. Both observation channels of a stereomicroscope 1 each contain a zoom system 30, wherein the zoom systems 30 vary the magnification synchronously. The zoom system 30 is usually an afocal zoom system, that is to say that upstream and downstream of the magnification system an imaging is to infinity. The likewise two-channel binocular tube is designated by 4. The illustrated construction of a stereomicroscope 1 permits an object situated in the object plane 2 to be imaged in highly magnified fashion onto the retina of an observer looking through the binocular tube 4. A documentation unit (camera) can also be connected in, instead of or in addition to the binocular tube 4.

An illumination system 20 is provided for illuminating an object situated in the object plane 2, wherein the illumination system 20 illustrated in FIG. 1 is a system with fibre illumination. It goes without saying that an illumination lamp with illumination optical unit can alternatively be provided. The optical waveguide 21 of the illumination system 20 radiates light into an illumination optical unit 22. The resulting illumination beam path is directed onto the object plane 2 via a deflection element 23 (prism) through the main objective 3 of the stereomicroscope 1. Illumination optical unit 22 and main objective 3 therefore focus the illumination beam path onto the object plane 2 and therefore define the geometry and brightness of the luminous field (illumination field). The illumination optical unit 22 can comprise an illumination zoom system, whereby the brightness and size of the luminous field can be controlled. In principle, such an illumination zoom system is constructed in the same way as the zoom system 30 of the stereomicroscope system 10, more precisely of the stereomicroscope 1.

The zoom system 30 has a stationary lens assembly 31 and also two lens assemblies 32 and 33 that can be displaced along the axis 8. Zoom systems 30 are also known in which a further stationary lens assembly 34 is furthermore present. By means of the relative displacement of the displaceable lens assemblies 32 and 33 relative to one another along the axis 8, a large magnification range can be traversed in a continuously variable manner. As already mentioned, the displacement of the lens assemblies 32 and 33 has to be effected highly precisely in a defined manner. High-precision mechanisms, gear systems and drives are necessary for this purpose. Finally, it is also the case that a specific minimum volume of the zoom system 30 cannot be undershot, with the result that known stereomicroscopes 1 of the type illustrated in FIG. 1 often have large extents in the vertical direction. This is disadvantageous particularly when the stereomicroscope 1 is used as a surgical microscope.

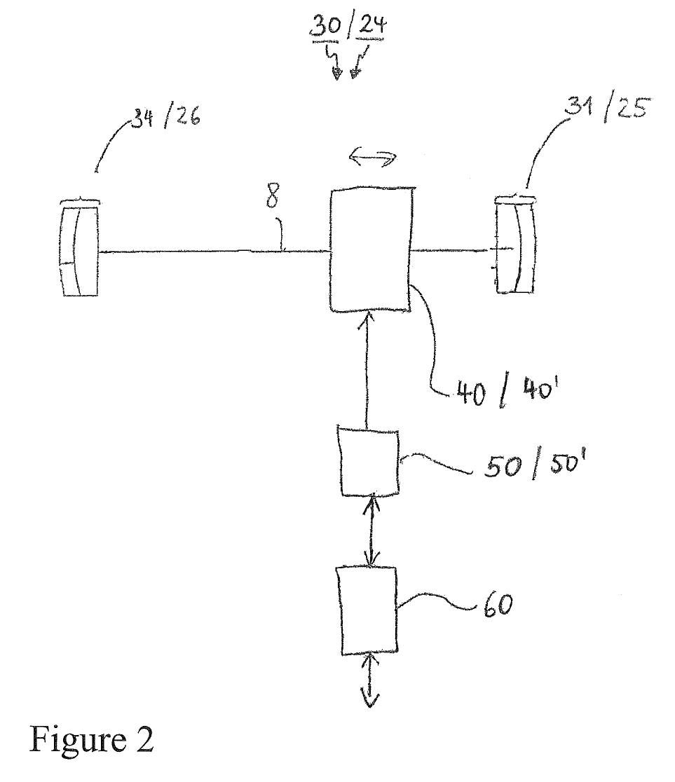

FIG. 2 shows highly schematically a zoom system 30 with SLM optical unit (40). The illustration shows a zoom system 30 with two stationary lens assemblies 31 and 34 (also cf. FIG. 1) and an SLM optical unit 40. The SLM optical unit 40, which is merely illustrated schematically, can additionally have one or more lens assemblies. The SLM optical unit 40 defined in this way can be displaceable along the axis 8. The following alternatives (not illustrated) are possible: it is possible to realize a zoom system 30 in which both stationary lens assemblies 31 and 34 each have an SLM optical unit. Further zoom elements can then be obviated. It is also possible for the two lens assemblies 31 and 34 to be replaced by SLM optical units, such as EAP lenses. A further solution is possible, in which one of the two stationary lens assemblies 31, 34 has an SLM optical unit, wherein a lens assembly that can be displaced along the axis 8 is additionally provided. If the displacement of one or more lens assemblies is necessary, then a highly precise guidance along the axis 8 in coordination with the driving of the SLM optical unit is necessary again, of course. Therefore, in the context of the present invention, a zoom system 30 in which no displaceable lens assemblies are present shall be preferred.

The schematically illustrated SLM optical unit 40 (in accordance with the definition above) is electronically driven by means of a control unit 50. The construction of a zoom system 30 with control unit 50 that has been described up to this point is also suitable, in principle, for an illumination zoom system 24 in an illumination system 20 (cf. FIG. 1). Therefore, a separate description of an illumination zoom system 24 can and will be omitted. The stationary lens groups of the illumination zoom system 24 are designated by 25 and 26. The SLM optical unit is designated by 40′ and the associated control unit is designated by 50′.

FIG. 2 furthermore illustrates a control unit 60, which can be used for coupling the zoom system 30 of the optical imaging system 10 to the illumination system 20, in particular to an illumination zoom system 24 of such an illumination system 20 (cf. FIG. 1). For this purpose, the control unit 60 is connected on the one hand to the control unit 50 for the SLM optical unit 40 of the zoom system 30 and on the other hand to a further control unit 50′ for the SLM optical unit 40′ of the illumination system 20. For this purpose, the corresponding elements 50′, 40′, 25 and 26 of the illumination zoom system 24 are notionally adjacent to the control unit 60 in a mirror-inverted manner (mirrored downwards at the element 60 in FIG. 2).

For setting the focal length within the illumination system 20, the illumination optical unit 22 of the illumination system 20 (cf. FIG. 1) generally has an SLM optical unit. This expediently involves an SLM optical unit having focusing properties. As already explained in the description, by way of example, micromirror arrays or liquid crystal lenses or else EAP lenses can be used for this purpose. In the case of using a micromirror array, the latter can also perform the function of the deflection element 23 (cf. FIG. 1). It is also conceivable to combine the SLM optical units mentioned, that is to say for example to provide a liquid crystal lens in the illumination optical unit 22 and additionally a micromirror array as a deflection element 23, in order to reinforce identical functions and/or to supplement different functions with one another. Thus, by way of example, the main task of a liquid crystal lens in the illumination optical unit 22 might reside in setting the focal length, while the main task of a micromirror array as a deflection element 23 might reside in varying the geometry of the luminous field. Furthermore, however, the micromirror array could also increase the dynamic range of the focus setting within the illumination system 20. The same considerations hold true if the illumination system 20 is provided with an illumination zoom system 24 (cf. FIG. 2).

The control unit 60 (cf. FIG. 2) can couple together the zoom system 30 and the illumination zoom system 24 constructed in the same way or more generally the SLM optical unit in the illumination system 20. This affords the possibility, in particular, of adjusting the luminous field diameter in the object plane 2 in an electronic manner without displaceable optical elements. This adjustment can be controlled by the setting of the magnification value of the zoom system 30, wherein the latter parameter is in turn correlated with a value that results from the driving of the SLM optical unit 40 by means of the control unit 50. The control unit 50 can therefore pass the corresponding value to the control unit 60, which, in a manner dependent thereon, drives the control unit 50′ for the SLM optical unit 40′ of the illumination system 20. In this way, the illumination field (luminous field) generated by the illumination system 20 can be adapted to the observation field that changes depending on the zoom setting.

Another practical configuration is the already discussed changeover between different operating states, which is advantageous particularly when the stereomicroscope 1 (cf. FIG. 1) is used as a surgical microscope. The use of the SLM optical units permits the changeover between two different focal lengths, that is to say, in the case of the zoom system 30, between two different magnifications or, in the case of the illumination system 20, between two different focal lengths within the illumination system 20, without passing through the intermediate focal lengths. In this way, it is possible for example to change over between different modes in which the luminous field in each case is optimally adapted to the observation field dependent on the respective zoom setting. In particular, a fast change between such modes is also possible. When the stereomicroscope 1 is used as an opthalmological surgical microscope, by way of example, the already discussed changeover from an operating state suitable for a cataract operation to an operating state suitable for a subsequent retina operation is possible in a simple and reliable manner.

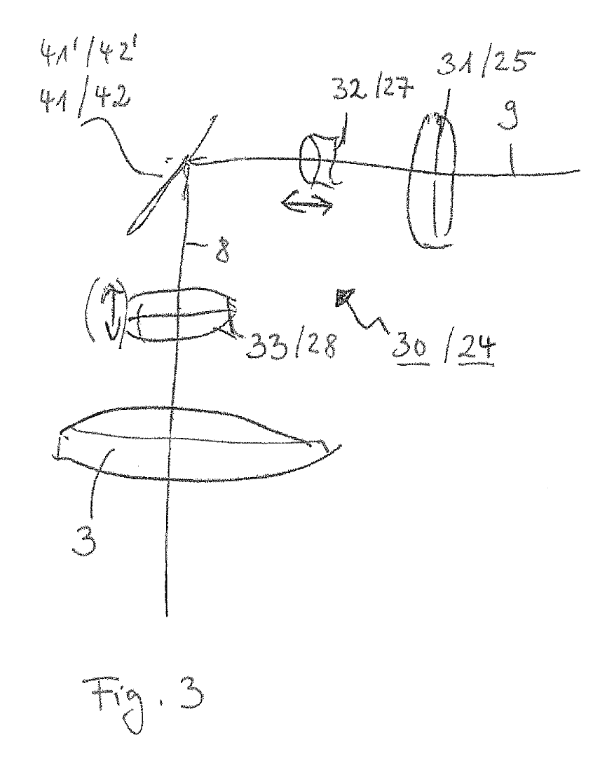

FIG. 3 shows an embodiment of a zoom system 30 (in this respect, cf. FIG. 1 and the explanations in respect thereof) with SLM optical unit in a further embodiment. The main objective 3 of the stereomicroscope 1 from FIG. 1 is likewise illustrated in FIG. 3. Here the zoom system 30 is constructed from three lens assemblies 31, 32 and 33, wherein the lens assemblies 32 and 33 can be mounted such that they are displaceable in each case individually or else jointly with one another along the axes 8 and 9. The observation beam path along the axis 8, which path runs substantially vertically during normal operation of the stereomicroscope 1 from FIG. 1, is directed into a horizontal plane by means of a reflective SLM optical unit. The view in accordance with FIG. 3 once again illustrates only one channel of the stereomicroscope; the second channel is situated behind the illustrated elements of the zoom system 30, such that the axis 9 together with the corresponding second axis (not illustrated) lying behind it spans a (horizontal) plane. A reflective microdisplay 41 or a micromirror array 42 is suitable as reflective SLM optical unit, wherein said micromirror array additionally has the focusing properties already mentioned. In the case of using a reflective microdisplay 41 without focusing properties, a further SLM optical unit is required in the zoom system 30 in order to set a variable magnification of the imaging. In this respect, reference should be made to the explanations in connection with FIG. 2.

The arrangement illustrated in FIG. 3 makes it possible to realize a “horizontal” and at the same time “relaxed” zoom system 30. Parts of the zoom system (lens assemblies 31, 32) are arranged “horizontally”, a “relaxation” of the zoom system simultaneously being made possible by means of the reflective SLM optical unit. With regard to “horizontal” zoom systems, reference should again be made to the documents in the name of the applicant (U.S. Pat. No. 7,057,807 B2; EP 1 424 581 B1; EP 1 460 466 B1) already mentioned in the introduction. The zoom system illustrated in FIG. 3 can advantageously be incorporated into the microscope systems illustrated in the documents mentioned. In order to avoid repetition, reference is explicitly made to the cited documents and the figures therein.

The possibility of distributing the components of the zoom system 30 between more than just one axis or plane, as illustrated in FIG. 3 (the axes 8 and 9 or the corresponding planes), makes it possible to provide the zoom system 30 with a long construction and thus to optimally correct image aberrations (“relaxed” zoom system).

As already explained with regard to FIG. 2, the zoom system illustrated in FIG. 3 can also constitute an illumination zoom system 24 of the illumination system 20. For this purpose, the illumination zoom system 24 has a stationary lens assembly 25 and two further (optionally displaceable) lens assemblies 27 and 28. All other explanations with regard to FIG. 3 hold true completely analogously for such an illumination zoom system 24. It should also be pointed out that the illumination beam path can either be led via the main objective 3 of the stereomicroscope 1, but that alternatively to this the illumination beam path can be led completely outside the main objective 3 in the direction of the object plane 2 (cf. FIG. 1).

By means of further deflection elements (traditional or SLM optical unit), the observation beam path (axis 9) illustrated in FIG. 3 can be directed into further horizontal planes. However, it is also possible to arrange further deflection elements (traditional or SLM optical unit) within the zoom system 30 in order to effect further deflections in a vertical and/or horizontal direction.

If the zoom elements of a zoom system are distributed in this way, the system can be provided with a long construction without being strained. The precise distribution of the zoom elements is performed with regard to optimization of the image correction.

The abovementioned deflection elements (traditional or SLM optical unit) can serve each individual optical channel of the stereomicroscope 1 or alternatively, in particular in order to make the adjustment simpler, a plurality of channels simultaneously. As already described, there are always at least two channels in order to avoid the described disadvantage of the magnification-dependent stereopsis.

It should once again be pointed out that the explanations in connection with a “relaxed” zoom system hold true completely analogously for the illumination zoom system 24 of the illumination system 20.

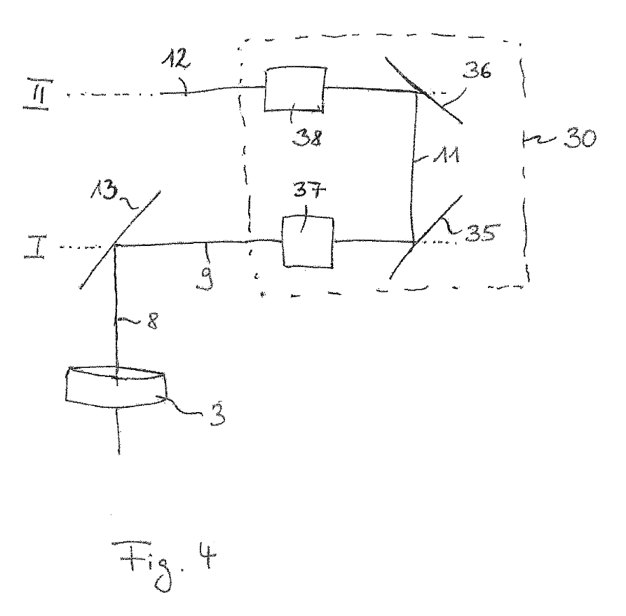

FIG. 4 schematically illustrates the already discussed possibility of distributing lens assemblies of a zoom system (including illumination zoom system again) between two horizontal planes of a stereomicroscope 1 that is in use. For the sake of simplicity, only the case of the zoom system 30 is discussed below. Proceeding from the main objective 3 of the stereomicroscope 1, the axis 8 of the observation beam path is directed into a first horizontal plane I by means of a first deflection element 13. The zoom system 30 is distributed between two horizontal planes I and II, for which purpose deflection elements 35 and 36 are used. Lens assemblies of the zoom system 30 are designated by 37 and 38 in FIG. 4. Various embodiments are possible in the case of the arrangement illustrated in FIG. 4: the lens assembly 37 can correspond to the lens assembly 34 from FIG. 1, while the deflection element 35 embodied as a micromirror array and having its focusing properties can perform the function of the lens assembly 33 from FIG. 1. The deflection element 36 embodied as a micromirror array correspondingly performs the function of the lens assembly 32 in accordance with FIG. 1. In this case, the lens assembly 38 represents the stationary lens assembly 31 in accordance with FIG. 1. The zoom system 30 illustrated in FIG. 4 therefore contains no displaceable elements, whereby the advantages already mentioned can be obtained.

In another embodiment, one of the deflection elements 35 or 36 can be a traditional deflection element (prism, mirror). In such a case it may be necessary to provide displaceable lens groups. The lens assemblies 37 or 38 should then be interpreted as a combination of a stationary lens assembly with a displaceable lens assembly. Finally, in this context, an arrangement is also conceivable in which a lens assembly is arranged between the deflection elements 35 and 36 in a vertical direction (axis 11). Finally, the lens assemblies 37,38 can also be combinations of lens assemblies and SLM optical units or pure SLM optical units (cf. FIG. 2). Separate illustrations of all the embodiments shall be dispensed with here, merely for reasons of simplicity.

The embodiments in accordance with FIGS. 3 and 4 that have been outlined realize “horizontal” zoom systems with the possibility of optimum image aberration correction. Stereomicroscopes comprising such zoom systems 30 on the one hand have a smaller construction than corresponding traditional stereomicroscopes 1 (cf. FIG. 1), but at the same time are also reduced in their depth extent by comparison with previous “horizontal” zoom systems, since not all the zoom components are arranged in one horizontal plane (I or II).

Consequently, such stereomicroscopes are optimally suitable for use as surgical microscopes.

### LIST OF REFERENCE SYMBOLS

1 Microscope, stereomicroscope
2 Object plane
3 Main objective
4 Binocular tube
5 Eyepiece
6 Tube lens
7 Deflection element
8 Axis
9 Axis
10 Optical imaging system, stereomicroscope system
11 Axis
12 Axis
13 Deflection element
20 Illumination system
21 Optical waveguide
22 Illumination optical unit
23 Deflection element
24 Illumination zoom system
25 Stationary lens assembly
26 Stationary lens assembly
27 Lens assembly
28 Lens assembly
30 Zoom system
31 Stationary lens assembly
32, 33 Displaceable lens assembly
34 Stationary lens assembly
35, 36 Deflection element
37, 38 Lens assembly
40, 40′ SLM optical unit
41, 41′ Reflective microdisplay
42, 42′ Micromirror array
50, 50′ Control unit for SLM optical unit
60 Control unit

What is claimed is:

1. An optical imaging system comprising:
a zoom system for adjusting a variable magnification of the image, wherein the zoom system comprises at least one of a lens assembly and a first SLM optical unit, and
an illumination system for illuminating an object to be imaged in an object plane, wherein
the illumination system has a second SLM optical unit for adjusting the focal length within the illumination system.

2. The optical imaging system according to claim 1, wherein at least one of the first and second SLM optical units is a reflective microdisplay.

3. The optical imaging system according to claim 2, wherein the reflective microdisplay is a reflective LCD.

4. The optical imaging system according to claim 1, wherein at least one of the first and second SLM optical units is a micromirror array having individually drivable micromirrors for adjustment of their spatial orientation.

5. The optical imaging system according to claim 1, wherein at least one of the first and second SLM optical units is a transmissive microdisplay.

6. The optical imaging system according to claim 5, wherein the transmissive microdisplay is at least one of a transmissive LCD and a liquid crystal lens.

7. The optical imaging system according to claim 1, wherein the second SLM optical unit of the illumination system is part of an illumination zoom system in the illumination system.

8. The optical imaging system according to claim 7, wherein the illumination zoom system of the illumination system is identical with the zoom system of the optical imaging system.

9. The optical imaging system according to claim 1, wherein at least one deflection element is provided within the zoom system of the optical imaging system.

10. The optical imaging system according to claim 9, wherein the first SLM optical unit of the zoom system of the optical imaging system is used as a deflection element.

11. The optical imaging system according to claim 9, wherein a plurality of first SLM optical units are provided in the zoom system of the optical imaging system, wherein at least two of said first SLM optical units are used as deflection elements.

12. The optical imaging system according to claim 1, wherein the illumination system has an illumination zoom system containing at least one deflection element.

13. The optical imaging system according to claim 12, wherein the second SLM optical unit is used as deflection element of the illumination zoom system.

14. The optical imaging system according to claim 12, wherein the illumination zoom system contains a plurality of second SLM optical units, wherein at least two of the plurality of second SLM optical units are used as deflection elements.

15. The optical imaging system according to claim 1, comprising a control unit for coupling the zoom system of the optical imaging system to the illumination system, wherein said control unit is configured to both drive the first SLM optical units of the zoom system of the optical imaging system and the second SLM optical units of the illumination system.

16. The optical imaging system according to claim 15, wherein the control unit is configured to adapt the illumination field generated by the illumination system to the observation field that changes depending on settings of the zoom.

17. The optical imaging system according to claim 15, wherein the control unit is configured to switch between different operating modes of the optical imaging system, each operating mode being defined by at least one particular magnification and one particular illumination of the object plane.

18. The optical imaging system according to claim 1, further comprising a microscope that is provided with the zoom system for adjusting the variable magnification of the image.

19. The optical imaging system according to claim 18, wherein the microscope is a stereomicroscope.

20. The optical imaging system according to claim 18, wherein the microscope is a surgical microscope.
